(19) United States
(12) Patent Application Publication
(10) Pub. No.: US 2016/0262462 A1
(43) Pub. Date: Sep. 15, 2016

(54) ELECTRONIC GARMENTS AND WEARABLE DEVICE SYSTEMS FOR ANIMALS

(71) Applicants: Masashi Kawamura, New York, NY (US); Jamie Carreiro, Brooklyn, NY (US); Qanta Shimizu, New York, NY (US); Eiji Muriochi, New York, NY (US); Jamie Nami Kim, Brooklyn, NY (US)

(72) Inventors: Masashi Kawamura, New York, NY (US); Jamie Carreiro, Brooklyn, NY (US); Qanta Shimizu, New York, NY (US); Eiji Muriochi, New York, NY (US); Jamie Nami Kim, Brooklyn, NY (US)

(21) Appl. No.: 15/069,103

(22) Filed: Mar. 14, 2016

Related U.S. Application Data
(60) Provisional application No. 62/133,261, filed on Mar. 13, 2015.

(51) Int. Cl. A41D 1/00; F21V 23/04; F21V 23/00; A01K 13/00; F21V 33/00

(52) U.S. Cl. CPC A41D 1/002; A01K 13/006; F21V 33/0008; F21V 23/003; F21V 23/0435; F21Y 2101/02

(57) ABSTRACT

Systems, apparatus, methods, and articles of manufacture provide for an electronic garment comprising a plurality of lights that may be controlled to display various types of images and messages. In one embodiment, the electronic garment is configured to be worn by a four-legged animal, such as a dog.

### CROSS-REFERENCE TO RELATED APPLICATIONS

The present application claims the benefit of priority of U.S. Provisional Patent Application No. 62/133,261 filed Mar. 13, 2015, entitled “GARMENT WITH ELECTRONIC DISPLAY FUNCTIONS FOR ANIMALS,” which is incorporated by reference in the present application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to wearable electronic display devices and garments, and particularly to garments configured to be worn by animals, and related communication and control systems.

### BACKGROUND

Various types of garments and wearable accessories for canines and felines are known. Some designs are intended to improve the visibility and safety of the wearer with respect to potential traffic hazards, or to assist in locating an animal. For example, some types of collars, harnesses, and leashes include reflective elements or lighting elements to improve visibility. However, previous garments for animals fail to provide customizable lighting options and/or fail to provide for remote control and management of lighting displays.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a diagram of a vest for a canine according to an embodiment of the present invention;

FIG. 2A is a block diagram of a system according to an embodiment of the present invention;

FIG. 2B is a block diagram of a system according to an embodiment of the present invention;

FIG. 3 is a diagram of a computer device according to an embodiment of the present invention;

FIG. 4 is a diagram of mobile device according to an embodiment of the present invention;

FIG. 5 is a diagram of mobile device according to an embodiment of the present invention;

FIG. 6 shows example user interfaces according to an embodiment of the present invention;

FIG. 7 shows an example user interface according to an embodiment of the present invention; and

FIG. 8 is an image of a microcontroller for a garment according to an embodiment of the present invention.

### DETAILED DESCRIPTION

It is an object of the present invention to overcome the drawbacks and shortcomings of conventional animal garments and accessories.

According to some embodiments, a garment is provided that can be worn by an animal, such as a dog, cat, other type of pet, or other type of four-legged animal, and which can generate light in varying colors, patterns, and/or arrays. For example, in one embodiment, a garment may be configured to generate light in particular colors, patterns, and/or arrays to produce a variety of images, letters, words, messages, signs, advertisements, and other forms of visual cues that may be recognized by an observer to convey certain information. This information, for example, may relate to improving the visibility of the wearer, locating or bringing attention to the animal wearing the garment, providing artistic or personalized messages or images, and/or conveying other types of information, whether such information is related or unrelated to the animal.

In one or more embodiments of this invention, a vest or other wearable garment may comprise, for example, a plurality of light emitting diodes (LEDs), and/or one or more other light-emitting sources, to generate light. The garment may comprise any variety of LEDs, including, for example, LEDs of various types, sizes, shapes, colors, powers, efficiencies, shock resistance, cycling, dimming, and/or luminosities, depending on the desired characteristics of the garment. In some embodiments, the garment may also comprise LEDs possessing certain capabilities including, for example and without limitation: flashing, voltage sensitivity, heat sensitivity, motion sensitivity, and/or heat generation.

According to some embodiments, a garment configured to be worn by an animal may comprise one or more microcontrollers configured with appropriate hardware, software, or both, to control one or more of various types of functions, including, for example and without limitation: color(s) displayed, color changes or transitions, luminosity, pattern(s) displayed, timing of pattern(s), messages, and/or on/off functionality of one or more individual lights.

According to one or more embodiments, a vest configured for a canine comprises a plurality of LED lights that are controllable using a smartphone or other type of mobile device. When lit, the LED lights help to keep the animal visible and safe in low light conditions and/or in potentially dangerous traffic conditions. In one embodiment, the dog vest is configurable to display a variety of animated patterns and custom scrolling text in one or more of thousands of colors.

In one embodiment, using an application or other interface a user may choose an animation, or type in a message to be displayed associated with a vest (e.g., using a paired smartphone in communication with the vest). Accordingly, an application may be used to control, from a distance, the lighting and display provided by LEDs. A user may be able to select animations, or choose a text mode and enter a message to be displayed. The interface may also provide controls for brightness and/or color, including two-color gradients that flow across the vest. In one embodiment, a user interface for a vest or other garment may provide a drawing mode that allows a user to design or input a design by selecting LEDs to make a desired pattern, which can then be available for display on the vest. In one example, a user interface allows a user to draw a pattern with her finger using a touchscreen.

In some embodiments, a vest or other garment comprises an LED grid and an outer layer over the LED grid. Preferably, the material of the outer layer is sufficiently permeable to light from the LED grid to allow any displayed messages or lighting patterns to be viewable through the material. In one example, the outer layer may be comprised of a material (e.g., neoprene) that provides a diffusing effect to the light from the underlying LEDs.

In some embodiments, a vest or other garment comprises waterproof and/or water resistant material for protecting an LED grid (and/or corresponding electronic components) from moisture. In one embodiment, a vest comprises a water-resistant layer (e.g., a vinyl layer) between an outer layer (e.g., a neoprene layer) and some or all of the electronic components of the vest. Advantageously, the water-resistant layer may keep moisture away from the LED grid, so the vest is resistant to light rain and splashes.

According to some embodiments, a vest may be configured with a “lost animal,” or “connection lost” mode of operation. In one example, if a canine wearing moves too far away from a paired computing device such as a smartphone (or vice versa), and a connection between the device and the vest is lost or is less than a predetermined signal strength (e.g., the range for maintaining a good Bluetooth™ connection is exceeded), the vest may automatically show a message (e.g., “LOST DOG”), thereby potentially attracting bystanders to help the lost animal find its way back to its owner.

According to some embodiments, a garment may comprise any arrangement or pattern of LEDs or other light sources suitable for making particular patterns or arrays, as deemed desirable for a particular implementation. For example, in some embodiments LEDs can be arranged physically in a manner appropriate for generating one or more symbols (e.g., stars, paw prints), pictures, alphanumeric characters, or the like.

According to some embodiments, a garment may comprise a plurality of LEDs placed on the top, bottom, back, and/or sides of the garment. In some embodiments, the LEDs can be arranged in a customizable pattern on the garment, for example, to spell out the name of a pet wearing the garment. In other embodiments, the LEDs can be arranged in rows, sheets, or in some uniform or non-uniform manner allowing for customizable images, animations, and/or messages to be displayed (e.g., scrolled) across the garment. Scrolling images, animations, and/or messages may include, for example, color gradients, moving stripes, an animated picture, “alarm” modes, blinking or “firefly” modes, advertising demos, sparkling colors, or a “lost pet” alert message (e.g., “LOST DOG”, “I'M LOST!”).

In some embodiments, a display array of a garment may include one or more display zones defined for the garment. For example, a left side display zone (e.g., configured to be on the left side of an animal when the animal is wearing the garment) and a right side display zone (e.g., configured to be on the right side of the animal) may be defined for a garment, allowing for identical displays to be generated in each respective zone (e.g., the same message may display on each side of a pet dog) and/or allowing for different displays to be generated in each respective zone.

In one non-limiting example configuration of a garment, provided for illustrative purposes only, the garment may comprise a plurality of Neopixels™ LEDs by Adafruit Industries, which are WS2812B 4-pin chip LEDs, each containing a respective microcontroller to control color and brightness individually. According to one example configuration, 256 LEDs may be arranged in 18 total rows.

In one non-limiting example configuration of a garment, a vest for an animal comprises 256 RGB LEDs, a microcontroller, a Bluetooth® low energy (LE) chip, and a 3.7V lithium polymer battery.

According to some embodiments, a vest for an animal comprises a grid including multiple LEDs and corresponding electronics, and the grid can easily be removed from the vest (e.g., to allow for safe washing of the vest).

According to some embodiments, a vest for an animal has adjustable sizing, with fasteners (e.g., Velcro™ closures) that allow a user to change the fit.

In one or more embodiments, a garment may also be configured to communicate with devices such as, for example, a remote control or a smartphone, through Bluetooth®, Wi-Fi®, or any other form of wired or wireless modes of communication. In some embodiments, an application compatible with a smartphone or other compatible device may be used to communicate with the garment remotely.

Although a wireless connection between a controller and the garment may be preferred by some types of users, in one or more embodiments a wire or other physical connection may connect the garment to a controller (e.g., a controlling application embodied in a smartphone).

According to one embodiment, a garment may comprise and communicate using a micro-controller unit (MCU) and may also comprise an integrated, single-chip, low energy integrated circuit (IC) for Bluetooth® connectivity.

In some embodiments, if an animal (e.g., a pet dog) a garment may be configured to automatically display a message or other information alerting others that the animal is lost, or otherwise drawing attention to the animal. For example, if an animal wearing a garment runs away from its owner, or wanders more than a predetermined maximum distance away from a controller device (e.g., a smartphone) paired or otherwise associated with the garment, the garment may automatically display a message. In one embodiment, a user may pre-program or remotely program the garment (e.g., using a smartphone, web app, or other user interface or controller device) to display certain information or messages if the garment is more than a predetermined maximum distance from the user (e.g., from the user's smartphone) and/or if the garment is not able to communicate with a controller device. In one example, a pet owner may store his or her phone number or other contact information as a message to be displayed to assist in retrieving the lost pet (e.g., “IF FOUND CALL (212) 555-4444”). In one embodiment, when the garment loses its Bluetooth® connectivity (or other type of wireless or wired connectivity) with a smartphone, a predefined message is displayed (e.g., a smartphone application retrieves a stored message in response to a trigger indicating a loss of proximity to the animal, and displays the retrieved message).

In accordance with some embodiments, a garment may comprise one or more motion sensors (e.g., multi-axis accelerometer), touch sensors, microphones, sound sensors, and/or temperature sensors.

In accordance with some embodiments, a garment may be made using one or more types of materials, such as, for example, waterproof vinyl, fleece, elastic synthetic fabric, or any other material suitable for a specific climate, season, or intended use.

In accordance with some embodiments, a garment may also include one or more zippers, hook and loop fasteners (e.g., Velcro™ fasteners), buttons, tabs, hooks, and/or other means to attach the garment to an animal.

In some embodiments, a garment may comprise one or more microphones and may be configured to provide for audio-reactive animations or other types of displays. For example, certain display patterns may be programmed to display automatically in response to certain volumes and/or types of sounds.

In some embodiments, a garment may comprise one or more touch sensors and may be configured to provide for interactive and/or touch-responsive displays. For example, certain display patterns may be programmed to display automatically in response to certain volumes and/or types of sounds.

Although some prominent examples described in this disclosure may relate to particular types of animals (e.g., pet dogs), it will be recognized, in light of this disclosure, that modifications may be made to some described embodiments in order to make the garment suitable (e.g., by adjusting the fit and number of LEDs appropriately) for various types of larger animals, smaller animals, and/or human users.

Particularly, some embodiments of the present invention provide for a canine vest that is easy to place on a dog, easy to adjust to accommodate the size and shape of the particular animal, easy to wash and maintain, configurable with customized and/or improved lighting and/or messaging functions, allows for configuration of the functions of the canine vest using a remote and/or wirelessly connected controller, and including a mode of operation that allows a predetermined message to be displayed (or some other predetermined action to be taken) should a controlling device lose a desired level of connectivity with the vest.

According to some embodiments, a garment comprises a chest section and a top section. The sections may be removably attached to each other by one or more types of fasteners (e.g., hook and loop fasteners). In a garment for a four-legged animal, the top section comprises a respective hole, gap, or cut-in for one or more of an animal's head and the animal's two front legs. In one embodiment, the top section comprises a back section to cover the top of the animal's back, and at least one side section to cover a side of the animal. The back section and the at least one side section may be integrated, for example, as stitched panels of the top section, or may be separate sections that can be removably attached to one another to form the top section.

According to some embodiments, a garment comprises a chest section, a back section, and two side sections. In some embodiments, a garment comprises a top section and two side sections. The sections may be removably attached to each other by one or more types of fasteners (e.g., hook and loop fasteners).

In one or more embodiments, at least one of a side section, a side panel of a top section, and/or a chest section comprises a respective hole, gap, or cut-in for one or more of an animal's head and the two front legs.

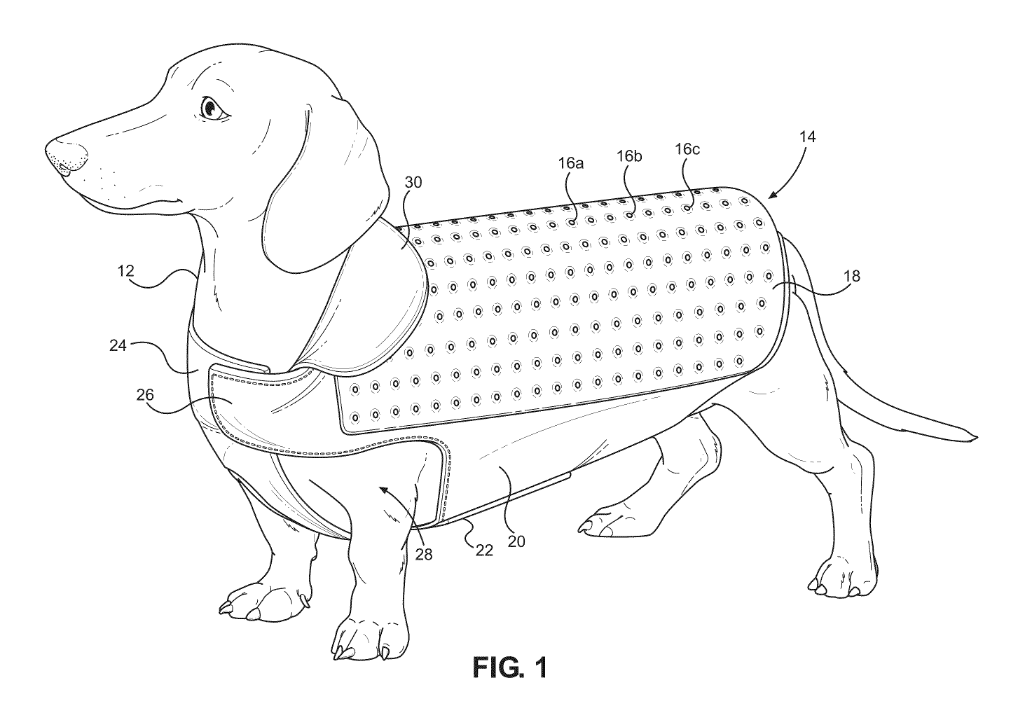

FIG. 1 displays an animal 12 wearing a garment 14, which is an example of a vest made in accordance with some embodiments of the present invention. In the depicted embodiment, the animal 12 is a dog. It should be appreciated that the example garment 14 may be modified for use with any four-legged animal, such as for example, a cat, a horse, a pig, etc., provided the components of the vest are sized appropriately.

The garment 14 includes three primary sections or portions, a first portion 18, a second portion 20, and a third portion 30. These portions may be called components, panels, sections, bodies, or members that make up some or all of the garment 14.

In this example vest embodiment, the first portion 18 is a lighting portion or a back portion, the second portion 20 is a chest portion, and the third portion 30 is a collar portion.

The first portion 18, as shown in FIG. 1, includes a plurality of LED lights 16a, 16b, 16c. Any number of LED lights may be used in accordance with a desired implementation. In some embodiments, the first portion 18 comprises a neoprene layer over a grid of LEDs, configured so that, when lit, the light from the LEDs is able to shine through the neoprene layer.

The second portion 20, as shown in FIG. 1, preferably includes respective side panels, on each side of the animal 12, that may be detachably connected underneath the animal 12. In one embodiment, the garment 14 further includes fastener portion 22 for detachably connecting a first side and a second side of the second portion 20 to secure the garment 14 under the animal 12.

The second portion 20 preferably comprises a fastener portion 26 for detachably connecting to a front portion 24, to secure the garment 14 at the front of the animal 12, as seen in FIG. 1.

As depicted in FIG. 1, when the fastener portion 22 is connected underneath the animal, and the fastener portion 26 is connected at the front of the animal an opening 28 is defined to allow for one of the front legs of the animal 12. In one embodiment, the second portion 20 comprises another opening (not shown) allowing for the other front leg of the animal 12.

Connecting the fastener portion 26 to the front portion 24 further defines an opening for the neck of the animal 12. As depicted in FIG. 1, the animal's neck is disposed within the neck opening, a left front leg is disposed within the left front leg opening 28, and the animal's right leg is disposed through a right front leg opening (not shown).

The collar portion 30 may comprise, in accordance with some embodiments, at least one controller device (e.g., a microcontroller device) (not shown) and at least one communications device (not shown). In one embodiment, a controller device may comprise both a processor device (e.g., a microprocessor) and a communications device (e.g., a Bluetooth™ network device).

According to some embodiments, a “user device” may comprise one or more types of computing devices that may be used by an end user. Some types of users may find it beneficial to use a mobile device controlled (e.g., by a processor executing computer software application instructions) in accordance with one or more of the embodiments described in this disclosure. In one example, a user device may comprise a smartphone or other personal mobile device. Other types of computing devices that may be used as user devices are discussed in this disclosure, and still others suitable for various embodiments will be apparent to those of ordinary skill in light of this disclosure.

As used in this disclosure, “mobile device” and “portable device” may refer to, without limitation, mobile telephones, cellular telephones, laptop computers, GPS navigation devices, smartphones, handheld computers, wearable computers, personal digital assistants, cellular telephones, network appliances, cameras, media players, game consoles, tablet computers, or any combination of any two or more of such computing devices.

It should be understood that the embodiments described in this disclosure are not limited to use with mobile devices (although some preferred embodiments are described with reference to such devices, for ease of understanding), but are equally applicable to any network device, user device, or other computing device, such as a personal desktop computer with a browser application and Internet access (e.g., in a user's home or office). Any embodiments described with reference to a mobile device in this disclosure should be understood to be equally applicable to any such other types of computing device, as deemed appropriate for any particular implementation(s).

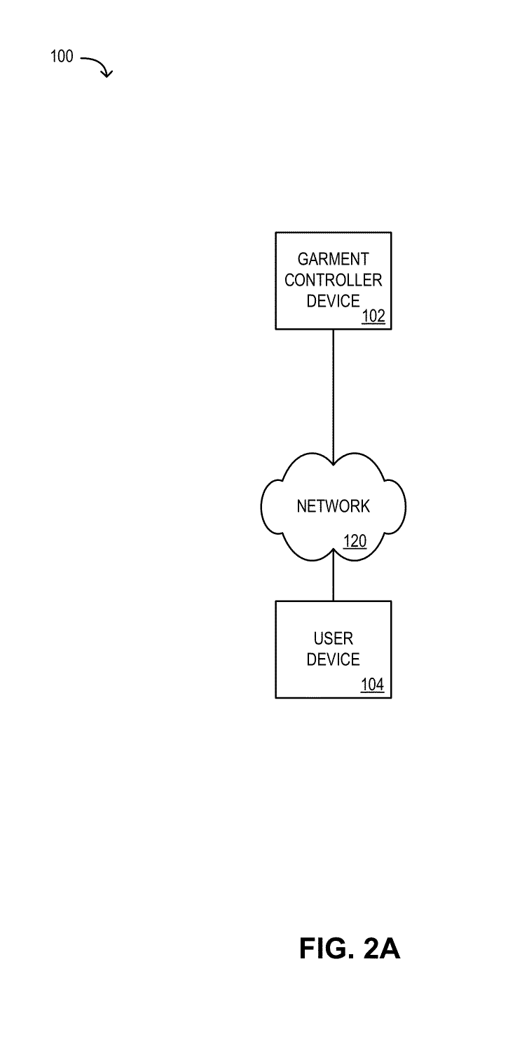

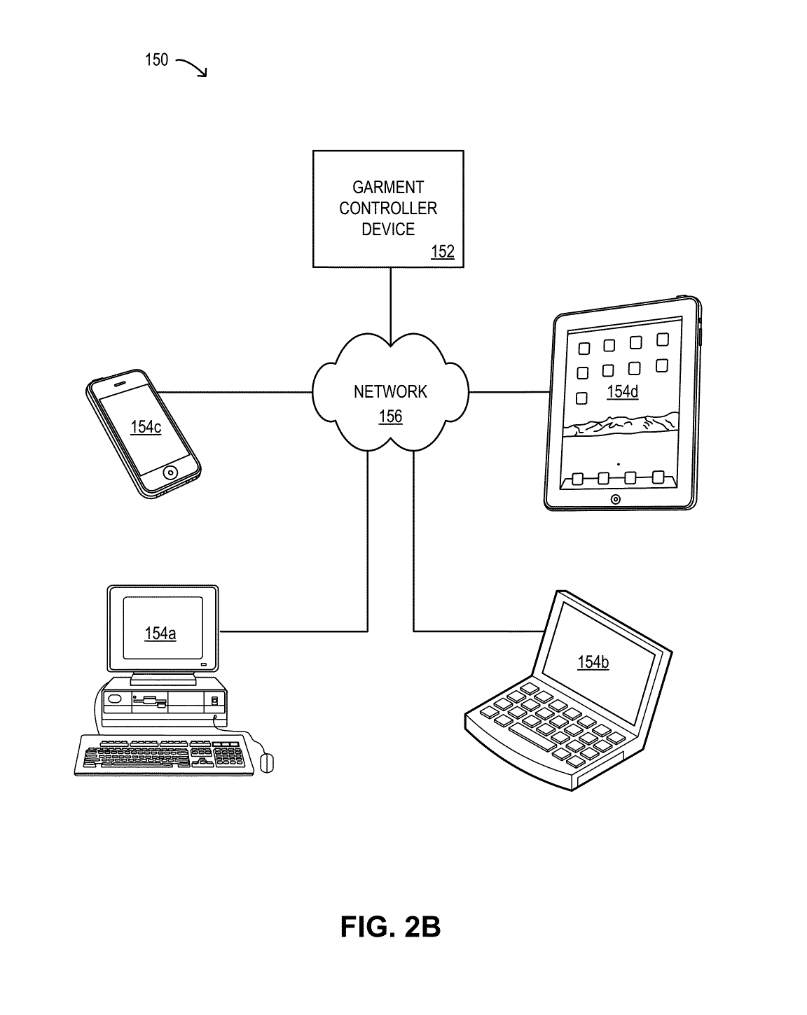

FIG. 2A depicts a block diagram of an example system 100 according to some embodiments. The system 100 may comprise one or more user devices 104 in communication with a garment controller device 102 via a network 120. Typically, a processor (e.g., one or more microprocessors, one or more microcontrollers, one or more digital signal processors) of a user device 104 or garment controller device 102 will receive instructions (e.g., from a memory or like device), execute those instructions, and perform one or more processes defined by those instructions. Instructions may be embodied, for example, in one or more computer programs and/or one or more scripts.

In some embodiments a garment controller device 102 and/or one or more of the user devices 104 stores and/or has access to information useful for performing one or more functions described in this disclosure. Such information may include one or more of: (i) display settings data, such as user-provided and/or application-provided data relating to information about light settings and/or message settings for use in generating lighting signals (e.g., using LEDs of an electronic garment); and/or (ii) communications data, such as information about a paired mobile device (e.g., a smartphone running an application).

In some embodiments, the garment controller device 102 may comprise one or more electronic and/or computerized controller devices configured to be communicatively coupled to interface with the user devices 104 (directly and/or indirectly). The garment controller device 102 may, for example, comprise and communicate using a micro-controller unit (MCU), such as the ATmega32U4™ MCU by Atmel Corporation. The garment controller device 102 may also comprise an integrated, single-chip, low energy integrated circuit (IC) for Bluetooth® connectivity, such as the nRF8001 Bluetooth® Smart™ Connectivity IC by Nordic Semiconductor ASA. The MCU and connectivity IC may be commercially available separately, or may be available packaged together, such as with the Blend Micro™ prototyping board from Red Bear Company Limited. The firmware may be programmed, for example, using an integrated development environment (IDE), such as the Arduino™ 1.6.1 IDE software from Arduino.

According to some embodiments, the garment controller device 102 (e.g., embodiment in a canine vest) may be wirelessly connected to a user device 104 (e.g., a user's smartphone) that is relatively close (e.g., close enough to maintain Bluetooth™ connectivity). In other embodiments, the garment controller device 102 may be located remote from the user devices 104, and may be in communication via a communications network (e.g., over the Internet, via one or more Wi-Fi® connections).

According to some embodiments, the garment controller device 102 may store and/or execute specially programmed instructions to operate in accordance with one or more embodiments described in this disclosure. The garment controller device 102 may, for example, execute one or more programs that facilitate receiving display setting instructions from a user device via the network 120.

In some embodiments, a user device 104 may comprise a mobile or portable computing device, and an application for configuring display settings for an electronic garment using the garment controller device. In some embodiments, the user device 104 may comprise a desktop computer (e.g., a Dell OptiPlex™ desktop by Dell, Inc.) and/or a workstation computer (e.g., a Dell Precision™ workstation by Dell Inc.).

In one or more embodiments, the garment controller device 102 may store some or all of the program instructions for generating light displays on an electronic garment, and the user device 104 may execute the application remotely via the network 120 and/or download from the server computer 102 (e.g., a web server) some or all of the program code for executing one or more of the various functions described in this disclosure.

Additional ways of distributing information and program instructions among one or more user devices 104 and/or garment controller device 102 will be readily understood by one skilled in the art upon contemplation of the present disclosure.

FIG. 2B depicts a block diagram of an example system 150 according to some embodiments. The system 150 may comprise one or more user devices 154a-d in communication with a garment controller device 152 via a network 156. According to some embodiments, the garment controller device 152 may comprise and/or may be in communication with one or more databases (not shown).

In some embodiments, the garment controller device 152 may comprise one or more electronic and/or computerized controller devices communicatively coupled to interface with the user devices 154a-d (directly and/or indirectly). According to some embodiments, the garment controller device 152 may be co-located with, in proximity to (e.g., sufficiently close to enable Bluetooth™ connectivity), or may be located remote from the user devices 154a-d.

The user devices 154a-d, in some embodiments, may comprise any types or configurations of mobile electronic network, user, and/or communication devices. User devices 154a-d may, for example, comprise cellular and/or wireless telephones such as an iPhone® manufactured by Apple, Inc. of Cupertino, Calif. or G4™ smartphones manufactured by LG® Electronics, Inc. of San Diego, Calif., and running the Android® operating system from Google, Inc. of Mountain View, Calif. The user device 154a may, as depicted for example, comprise a personal or desktop computer (PC), the user device 154b may comprise a laptop computer, the user device 154c may comprise a smartphone, and the user device 154d may comprise a tablet computer.

Typically, a processor (e.g., one or more microprocessors, one or more microcontrollers, one or more digital signal processors) of a user device 154a-d or garment controller device 152 will receive specially programmed instructions (e.g., from a memory or like device), execute those instructions, and perform one or more processes defined by those instructions. Instructions may be embodied for example, in one or more computer programs and/or one or more scripts.

In some embodiments a garment controller device 152 and/or one or more of the user devices 154a-d stores and/or has access to data useful for providing one or more functions described in this disclosure, in a manner similar to that described with respect to system 100.

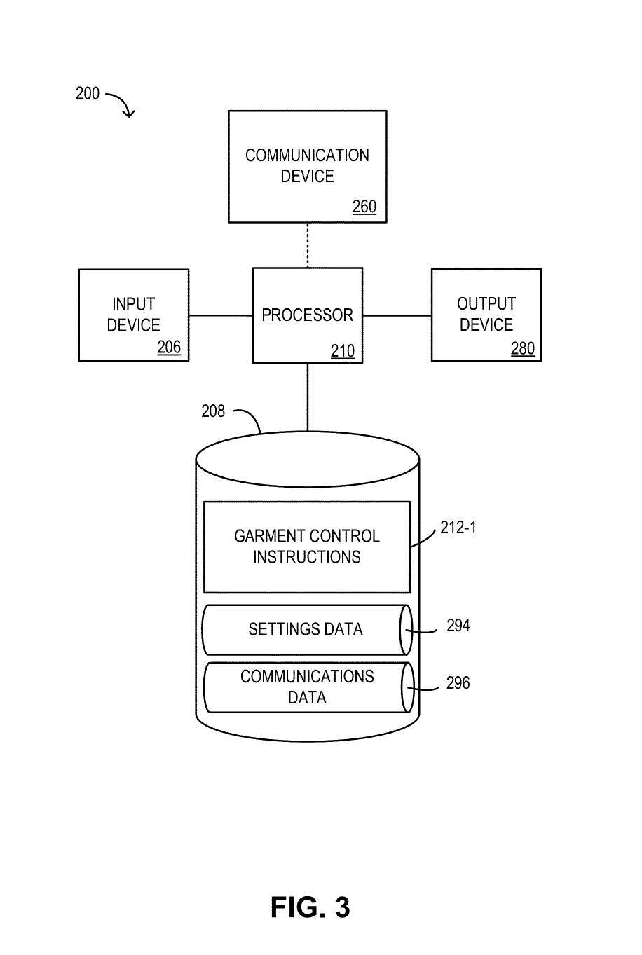

Turning to FIG. 3, a block diagram of an apparatus 200 according to some embodiments is shown. In some embodiments, the apparatus 200 may be similar in configuration and/or functionality to any of user device 104, garment controller device 102, the garment controller device 152, and/or user devices 154a-d. The apparatus 200 may, for example, execute, process, facilitate, and/or otherwise be associated with any of the example processes or interfaces described in conjunction with any of the processes in this disclosure.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described in this disclosure.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a physical and/or virtual keyboard that allows an operator of the apparatus 200 to interface with the apparatus 200 (e.g., such as to enter data or compose an electronic message). The input device 206 may comprise, for example, one or more of a pointer device (e.g., a mouse), a camera, and/or a headphone jack. Input device 206 may include one or more of a keypad, touch screen, or other suitable tactile input device. Input device 206 may include a microphone comprising a transducer adapted to provide audible input of a signal that may be transmitted (e.g., to the processor 210 via an appropriate communications link) and/or an accelerometer or other device configured to detect movement of the device.

The output device 280 may, according to some embodiments, comprise one or more lights (e.g., LED lights), a display screen, and/or other practicable output component and/or device. The output device 280 may, for example, provide an indication of configurable lights of a lighting display (e.g., configurable with respect to whether they are lit, and with respect to specific colors). Output device 280 may include one or more speakers comprising a transducer adapted to provide audible output based on a signal received (e.g., via processor 210), such as for outputting an audio message when an electronic garment goes into a “lost dog” mode.

According to some embodiments, the input device 206 and/or the output device 280 may comprise and/or be embodied in a single device, such as a touch-screen display.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals to a server in communication with a plurality of handheld, mobile and/or telephone devices. According to some embodiments, the communication device 260 may also or alternatively be coupled to the processor 210.

Communication device 260 may include, for example, a receiver and a transmitter configured to communicate via signals according to one or more suitable data and/or voice communication systems. In some embodiments, the communication device 260 may comprise an IR, RF, Bluetooth™, and/or Wi-Fi® network device coupled to facilitate communications between the processor 210 and another device (such as one or more mobile devices, server computers, central controllers, and/or third-party data devices). For example, communication device 260 may communicate voice and/or data over mobile telephone networks such as GSM, CDMA, CDMA2000, EDGE or UMTS. Alternatively, or in addition, communication device 260 may include receiver/transmitters for data networks including, for example, any IEEE 802.x network such as Wi-Fi or Bluetooth™.

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 208 may, according to some embodiments, garment control instructions 212-1 (e.g., as non-transitory computer-readable software code), settings data 294 and/or communications data 296. In some embodiments, the garment control instructions 212-1 may be utilized by the processor 210 to provide output information (e.g., via the output device 280 and/or the communication device 260 of the user devices 104 and/or 154a-d, respectively).

According to some embodiments, garment control instructions 212-1 may be operable to cause the processor 210 to process settings data 294 as described in this disclosure, for example, to generate or otherwise determine at least one lighting display setting and/or message corresponding (e.g., from a user's mobile device). In some embodiments, determined lighting display information (e.g., light color, timing, pattern, and/or message information) may be stored locally and/or remotely in a database.

Any or all of the exemplary instructions and data types and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

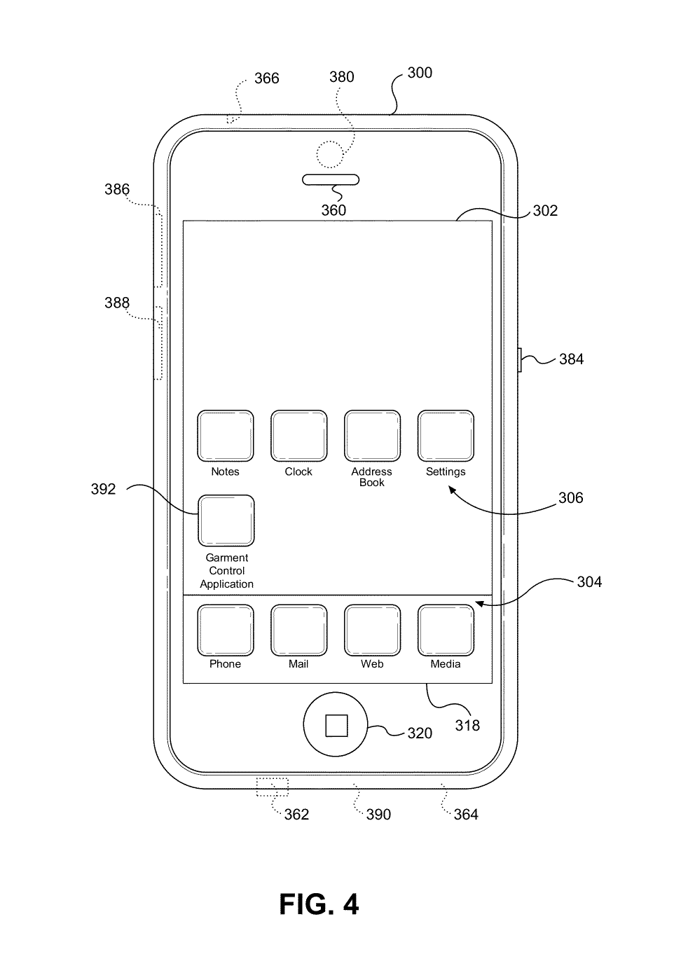

Turning to FIG. 4, a block diagram of an example mobile device 300 according to some embodiments is shown. In some embodiments, the mobile device 300 comprises a touch-sensitive display 302. The touch-sensitive display may be implemented with liquid crystal display (LCD) technology, light emitting polymer display (LPD) technology, or some other display technology. The touch-sensitive display 302 may be sensitive to haptic and/or tactile contact with a user. In some embodiments, the touch-sensitive display 302 may comprise a multi-touch-sensitive display that can, for example, process multiple simultaneous touch points, including processing data related to the pressure, degree, and/or position of each touch point. Such processing facilities gestures and interactions with multiple fingers, chording, and other interactions. Alternately or in addition, other touch-sensitive display technologies may be used, such as, without limitation, a display in which contact is made using a stylus or other pointing device.

In some embodiments, the mobile device 300 may be adapted to display one or more graphical user interfaces on a display (e.g., touch-sensitive display 302) for providing the user access to various system objects and/or for conveying information to the user. In some embodiments, the graphical user interface may include one or more display objects 304, 306, such as icons or other graphic representations of respective system objects. Some examples of system objects include, without limitation, device functions, applications, windows, files, alerts, events, or other identifiable system objects.

In some embodiments, the mobile device 300 may implement multiple device functionalities, such as a telephony device, a network data communication device, and a media processing device. In some embodiments, particular display objects 304 may be displayed in a menu bar 318. In some embodiments, device functionalities may be accessed from a top-level graphical user interface, such as the graphical user interface illustrated in FIG. 4. Touching one of the display objects 304 can, for example, invoke corresponding functionality.

Touching the example “Garment Control Application” object 392 may, for example, invoke a lighting display environment, and supporting functionality, as described in this disclosure with respect to various embodiments; likewise, a selection of any of the display objects 306 may invoke a corresponding object environment and functionality.

In some embodiments, the mobile device 300 may include one or more input/output (I/O) devices and/or sensor devices. For example, a speaker 360 and a microphone 362 may be included to facilitate voice-enabled functionalities, such as phone and voice mail functions. In some embodiments, an up/down button 384 for volume control of the speaker 360 and the microphone 362 may be included. In some embodiments, a loudspeaker 364 may be included to facilitate hands-free voice functionalities, such as speaker phone functions. An audio jack 366 may also be included for use of headphones and/or a microphone.

In some embodiments, an accelerometer (not shown) may be utilized to detect movement of the mobile device 300.

In some embodiments, the mobile device 300 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some embodiments, a positioning system (e.g., a GPS receiver) may be integrated into the mobile device 300 (e.g., embodied as a mobile type of user device, such as a tablet computer or smartphone) or provided as a separate device that may be coupled to the mobile device 300 through an interface (e.g., via communication device 260) to provide access to location-based services.

In some embodiments, a port device 390, e.g., a Universal Serial Bus (USB) port, or a docking port, or some other wired port connection, may be included in mobile device 300. The port device 390 may, for example, be utilized to establish a wired connection to other computing devices, such as other communication devices 300, network access devices, a personal computer, a printer, a display screen, or other processing devices capable of receiving and/or transmitting data.

The mobile device 300 may also include a camera lens and sensor 380. In some embodiments, the camera lens and sensor 380 may be located on the back surface of the mobile device 300. The camera may capture still images and/or video.

The mobile device 300 may also include one or more wireless communication subsystems, such as an 802.11b/g communication device 386, and/or a Bluetooth™ communication device 388. Other communication protocols may also be supported, including other 802.x communication protocols (e.g., WiMax, Wi-Fi, 3G), code division multiple access (CDMA), global system for mobile communications (GSM), Enhanced Data GSM Environment (EDGE), etc.

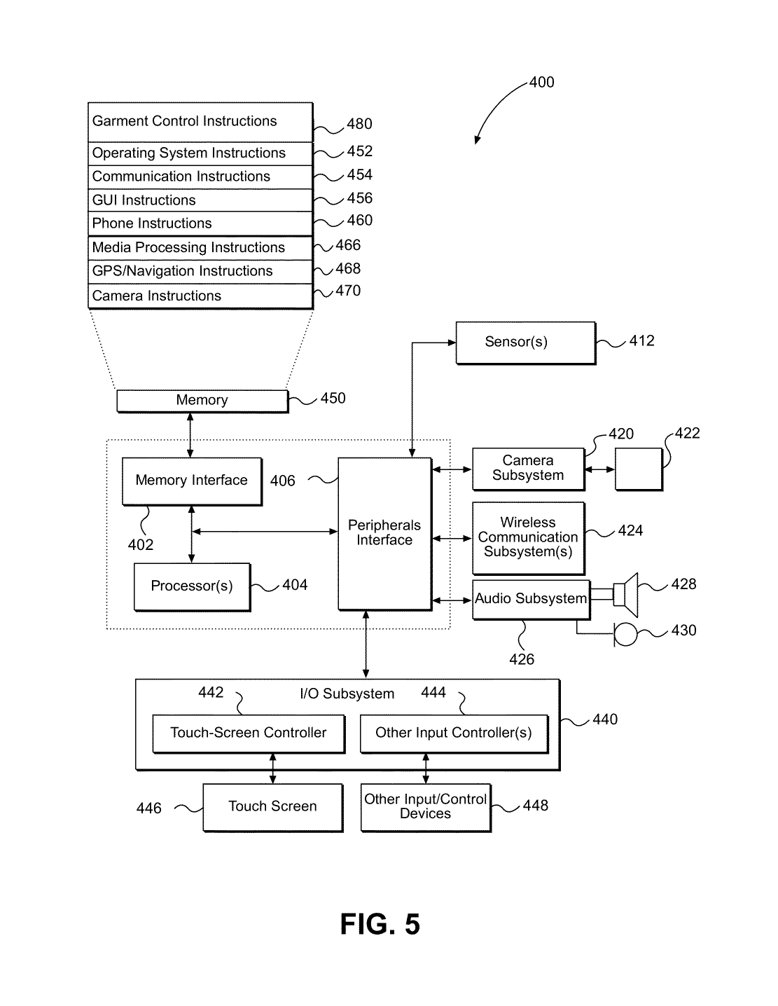

FIG. 5 is a block diagram of an example architecture for the mobile device of FIG. 4. The mobile device 300 may include a memory interface 402, one or more data processors, image processors and/or central processing units 404, and a peripherals interface 406. The memory interface 402, the one or more processors 404 and/or the peripherals interface 406 may be separate components or may be integrated in one or more integrated circuits. The various components in the mobile device 300 may be coupled by one or more communication buses or signal lines.

Sensors, devices, and subsystems may be coupled to the peripherals interface 406 to facilitate multiple functionalities. For example, a motion sensor 410, a light sensor 412, and a proximity sensor 414 may be coupled to the peripherals interface 406 to facilitate the orientation, lighting, and proximity functions described with respect to FIG. 4. Other sensors 416 may also be connected to the peripherals interface 406, such as a positioning system (e.g., GPS receiver), a temperature sensor, a biometric sensor, or other sensing device, to facilitate related functionalities.

A camera subsystem 420 and an optical sensor 422, e.g., a charged coupled device (CCD) or a complementary metal-oxide semiconductor (CMOS) optical sensor, may be utilized to facilitate camera functions, such as recording photographs and video clips.

Communication functions may be facilitated through one or more wireless communication subsystems 424, which may include radio frequency receivers and transmitters and/or optical (e.g., infrared) receivers and transmitters. The specific design and embodiment of the communication subsystem 424 may depend on the communication network(s) over which the mobile device 300 is intended to operate. For example, a mobile device 300 may include communication subsystems 424 designed to operate over a GSM network, a GPRS network, an EDGE network, a Wi-Fi or WiMax network, and a Bluetooth™ network. In particular, the wireless communication subsystems 424 may include hosting protocols such that the device 300 may be configured as a base station for other wireless devices.

An audio subsystem 426 may be coupled to a speaker 428 and a microphone 430 to facilitate voice-enabled functions, such as voice recognition, voice replication, digital recording, and telephony functions.

The I/O subsystem 440 may include a touch screen controller 442 and/or other input controller(s) 444. The touch-screen controller 442 may be coupled to a touch screen 446. The touch screen 446 and touch screen controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 446.

The other input controller(s) 444 may be coupled to other input/control devices 448, such as one or more buttons, rocker switches, thumb-wheel, infrared port, USB port, and/or a pointer device such as a stylus. The one or more buttons (not shown) may include an up/down button for volume control of the speaker 428 and/or the microphone 430.

The memory interface 402 may be coupled to memory 450. The memory 450 may include high-speed random access memory and/or non-volatile memory, such as one or more magnetic disk storage devices, one or more optical storage devices, and/or flash memory (e.g., NAND, NOR). The memory 450 may store an operating system 452, such as Darwin, RTXC, LINUX, UNIX, OS X, WINDOWS, or an embedded operating system such as VxWorks. The operating system 452 may include instructions for handling basic system services and for performing hardware dependent tasks. In some embodiments, the operating system 452 may be a kernel (e.g., UNIX kernel).

The memory 450 may also store communication instructions 454 to facilitate communicating with one or more additional devices, one or more computers and/or one or more servers.

The memory 450 may include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes and instructions; and/or camera instructions 470 to facilitate camera-related processes and functions.

The memory 450 may also store garment control instructions 480 for facilitating the configuration and settings for one or more electronic garments, such as by setting lighting patterns, styles, colors, sounds, timing, frequency, and/or messages and/or images to be displayed. In some embodiments, garment control instructions 480 allow a user to select (e.g., via touch screen 446) one or more settings for generating visual output (e.g., to produce a lighting display via an LED grid) and/or audio output (e.g., to produce audible output via a speaker of an electronic garment) and/or transmit (e.g., via wireless communication subsystem(s) 424) settings data to at least one electronic garment.

Each of the above identified instructions and applications may correspond to a set of instructions for performing one or more functions described above. These instructions need not be implemented as separate software programs, procedures, or modules. The memory 450 may include additional instructions or fewer instructions. Furthermore, various functions of the mobile device 300 may be implemented in hardware and/or in software, including in one or more signal processing and/or application specific integrated circuits.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described in this disclosure.

Any or all the methods described in this disclosure may involve one or more interface(s). One or more of such methods may include, in some embodiments, providing an interface by and/or through which a user may review and/or establish one or more types of settings for configuring an electronic garment. Although certain types of information are illustrated in the example interfaces, those skilled in the art will understand that the interfaces may be modified in order to provide for additional types of information and/or to remove some of the illustrated types of information, as deemed desirable for a particular implementation.

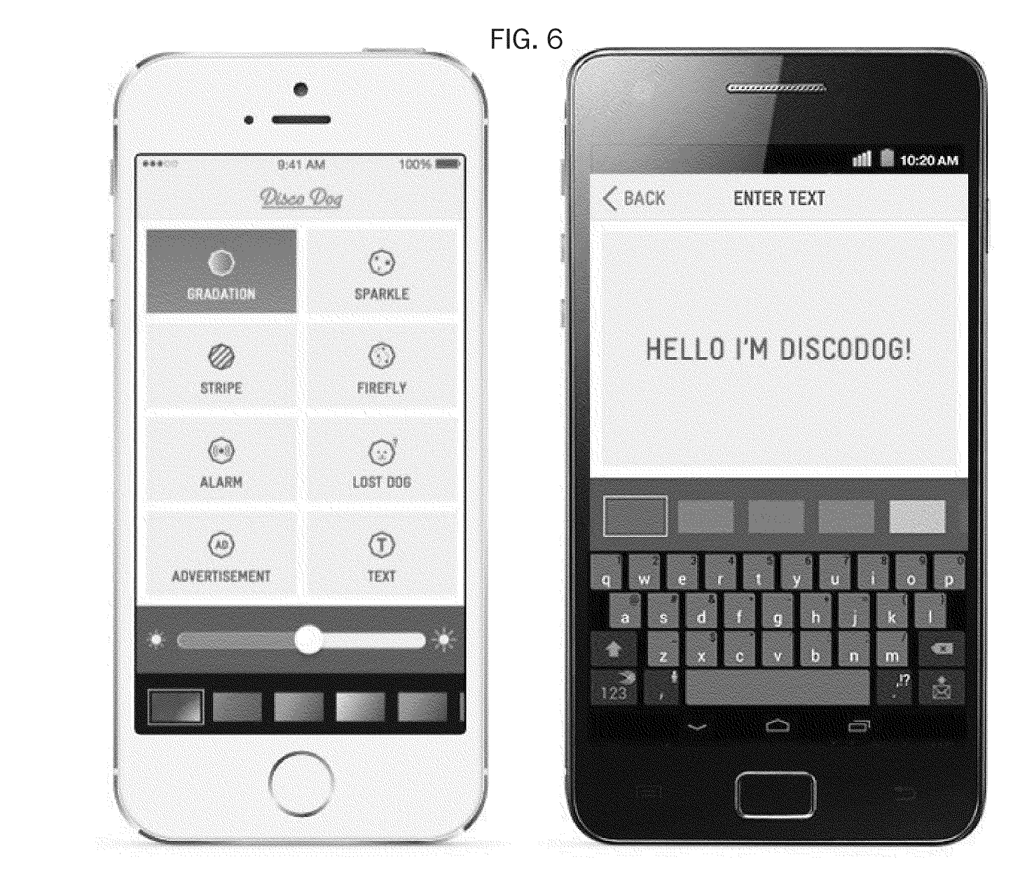

FIG. 6 depicts examples of user interfaces for controlling an electronic garment (e.g., garment 14 of FIG. 1) according to some embodiments. For example, the left user interface depicts an example of an interface for a garment control application. As shown in the example, several preset example lighting display configurations may be available for selection by a user. On selection, the garment control application may transmit to a garment (e.g., a canine vest) a signal to direct a controller device of the electronic garment to display the selected display. As depicted in the example user interface on the right, a user may be able to enter a message to display via a LED grid of an electronic garment.

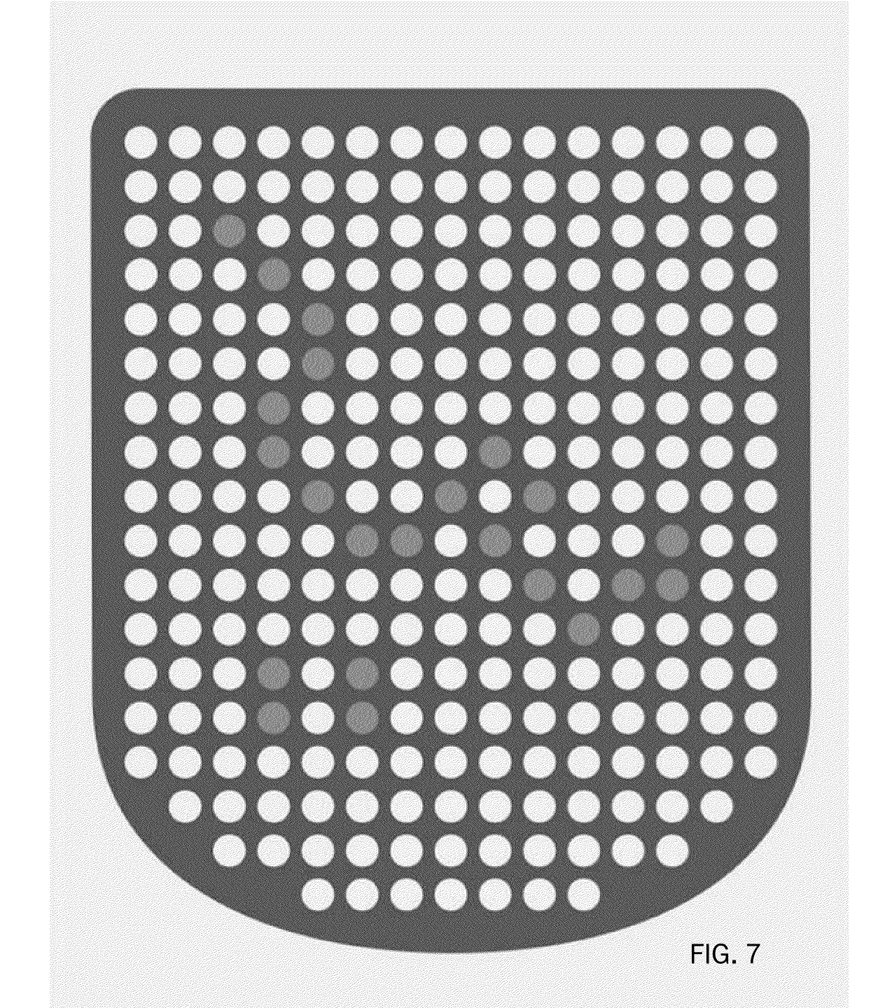

FIG. 7 depicts an example of a user interface for inputting a pattern to be displayed via a lighting display of an electronic garment. For example, a user may be able to select, via a touch screen or other input device of a mobile device, a desired pattern to be displayed on an LED grid of canine vest.

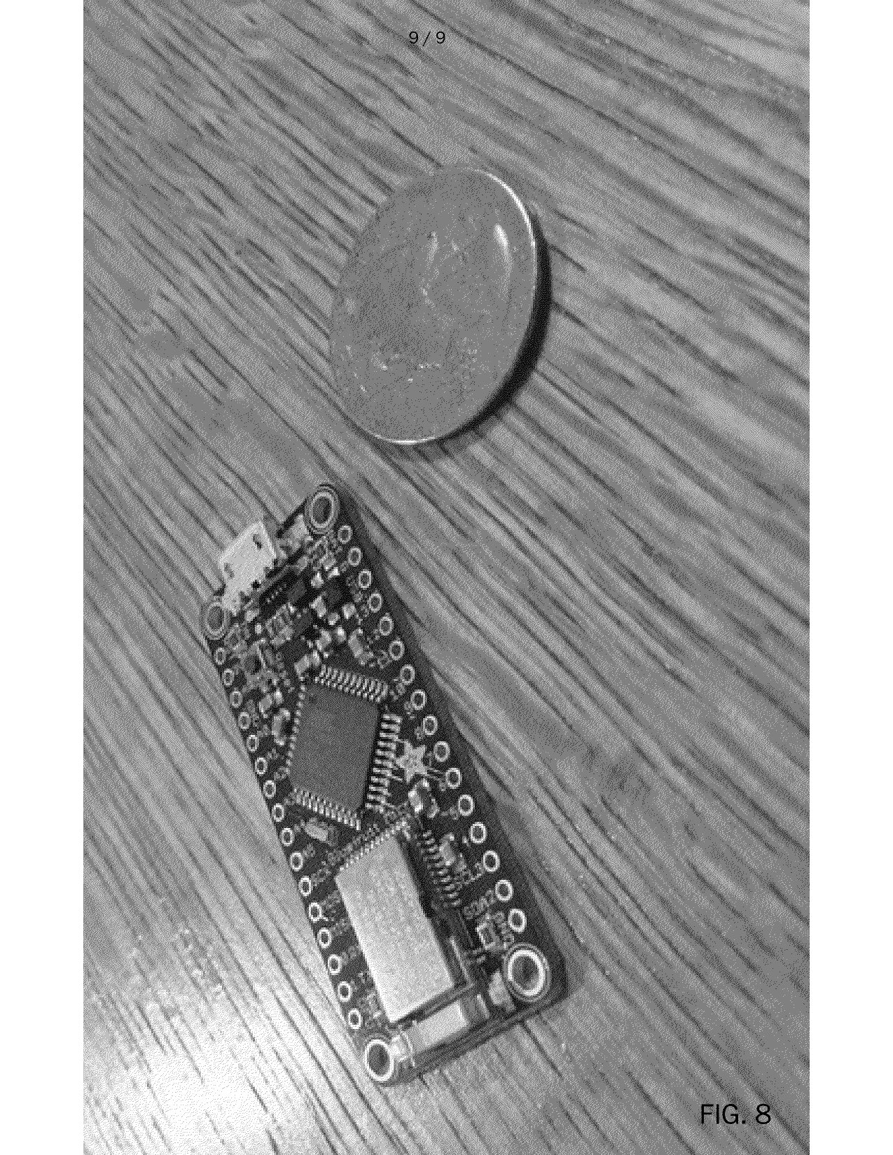

FIG. 8 depicts an example of a microcontroller comprising a processor and a Bluetooth™ communications component. The displayed quarter is merely for purposes of showing an example scale of the microcontroller.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (set forth at the beginning of the first page of this disclosure) nor the Abstract (set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

Some embodiments may be associated with a “network” or a “communication network”. As used in this disclosure, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. In some embodiments, networks may be hard-wired, wireless, virtual, neural, and/or any other configuration or type of network that is or becomes known. Networks may comprise any number of computers and/or other types of devices in communication with one another, directly or indirectly, via a wired or wireless medium such as the Internet, LAN, WAN or Ethernet (or IEEE 802.3), Token Ring, RF, cable TV, satellite links, or via any appropriate communications means or combination of communications means. In some embodiments, a network may include one or more wired and/or wireless networks operated in accordance with any communication standard or protocol that is or becomes known or practicable. Exemplary protocols for network communications include but are not limited to: the Fast Ethernet LAN transmission standard 802.3-2002® published by the Institute of Electrical and Electronics Engineers (IEEE), Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Communication between and/or among devices may be encrypted to ensure privacy and/or prevent fraud in any one or more of a variety of ways well known in the art.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described in this disclosure are associated with an “indication”. The term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

“Determining” something may be performed in a variety of manners and therefore the term “determining” (and like terms) includes calculating, computing, deriving, looking up (e.g., in a table, database or data structure), ascertaining, recognizing, and the like.

A “processor” means any one or more microprocessors, Central Processing Unit (CPU) devices, computing devices, microcontrollers, digital signal processors, or like devices. Examples of processors include, without limitation, INTEL's PENTIUM, AMD's ATHLON, or APPLE's A6 processor.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate). Where more than one device or article is described in this disclosure (whether or not they cooperate), a single device or article may alternatively be used in place of the more than one device or article that is described. For example, a plurality of computer-based devices may be substituted with a single computer-based device. Accordingly, functionality that is described as being possessed by more than one device or article may alternatively be possessed by a single device or article. The functionality and/or the features of a single device that is described may be alternatively embodied by one or more other devices that are described but are not explicitly described as having such functionality and/or features. Thus, other embodiments need not include the described device itself, but rather can include the one or more other devices that would, in those other embodiments, have such functionality/features.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

It will be readily apparent that the various methods and algorithms described in this disclosure may be implemented by, e.g., appropriately- and/or specially-programmed general purpose computers and/or computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

Accordingly, a description of a process likewise describes at least one apparatus for performing the process, and likewise describes at least one computer-readable medium and/or computer-readable memory for performing the process. The apparatus that performs a described process may include components and/or devices (e.g., a processor, input and output devices) appropriate to perform the process. A computer-readable medium may store program elements and/or instructions appropriate to perform a described method.

The term “computer-readable medium” refers to any medium that participates in providing data (e.g., instructions or other information) that may be read by a computer, a processor, or a like device. Various forms of computer-readable media may be involved in carrying data, including sequences of instructions, to a processor. For example, sequences of instruction (i) may be delivered from RAM to a processor, (ii) may be carried over a wireless transmission medium, and/or (iii) may be formatted according to any one or more of various known formats, standards, or protocols (some examples of which are described in this disclosure with respect to communication networks).

Computer-readable media may take many forms, including but not limited to, non-volatile media, volatile media, and transmission media. Non-volatile media may include, for example, optical or magnetic disks and other types of persistent memory. Volatile media may include, for example, DRAM, which typically constitutes the main memory for a computing device. Transmission media may include, for example, coaxial cables, copper wire, and fiber optics, including the wires that comprise a system bus coupled to the processor. Transmission media may include or convey acoustic waves, light waves, and electromagnetic emissions, such as those generated during RF and IR data communications. Common forms of computer-readable media include, for example, a floppy disk, a flexible disk, a hard disk, magnetic tape, any other magnetic medium, a CD-ROM, DVD, any other optical medium, a punch card, paper tape, any other physical medium with patterns of holes, a RAM, a PROM, an EPROM, a FLASH-EEPROM, a Universal Serial Bus (USB) memory stick or thumb drive, a dongle, any other memory chip or cartridge, a carrier wave, or any other medium from which a computer can read.

The term “computer-readable memory” may generally refer to a subset and/or class of non-transitory computer-readable medium that does not include intangible or transitory signals, waves, waveforms, carrier waves, electromagnetic emissions, or the like. Computer-readable memory may typically include physical, non-transitory media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, USB devices, any other memory chip or cartridge, and the like.

Where databases are described, it will be understood by one of ordinary skill in the art that (i) alternative database structures to those described may be readily employed, and (ii) other memory structures besides databases may be readily employed. Any illustrations or descriptions of any sample databases presented in this disclosure are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries may be different from those described in this disclosure. Further, despite any depiction of the databases as tables, other formats (including relational databases, object-based models, hierarchical electronic file structures, and/or distributed databases) could be used to store and/or manipulate the described data. Likewise, object methods or behaviors of a database may be used to implement one or more of various processes, such as those described in this disclosure. In addition, the databases may, in a known manner, be stored locally and/or remotely from a device that accesses data in such a database. Furthermore, while unified databases may be contemplated, it is also possible that the databases may be distributed and/or duplicated amongst a variety of devices.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. An electronic garment comprising:
a first portion comprising a plurality of lights;
at least one fastener for securing the first portion to a wearer;
a power source connected to the plurality of lights;
a communications device; and
a processor in communication with the plurality of lights and with the communications device.

2. The electronic garment of claim 1, wherein at least one of the plurality of lights is an LED.

3. The electronic garment of claim 1, wherein processor is configured to control operation of the plurality of lights.

4. The electronic garment of claim 1, further comprising:
a data storage device storing computer-readable instructions that when executed by the processor direct the processor to control operation of the plurality of lights.

5. The electronic garment of claim 5, the computer-readable instructions further directing the processor to identify when the communications device loses connectivity to a user device.

6. The electronic garment of claim 6, the computer-readable instructions further directing the processor to control the plurality of lights to display a message in response to identifying that the communications device lost connectivity to the user device.

7. The electronic garment of claim 1, wherein the processor further is in communication with a user device via the communications device.

8. The electronic garment of claim 1, wherein the user device comprises a garment control application for directing the processor to control operation of the plurality of lights.

9. The electronic garment of claim 1, wherein the garment control application comprises a user interface for selecting one of a plurality of preset display settings.

10. The electronic garment of claim 1, wherein the garment control application comprises a user interface for a user to enter a customized display.

11. A canine vest comprising:
a top portion comprising a plurality of lights;
a collar portion attached to the top portion and including a microcontroller, a power source, and a communications device; and
a chest portion attached to the top portion and including at least one fastener for securing the chest portion to a canine.

12. A method comprising:
detecting that a canine vest has lost connectivity with a mobile device associated with the canine vest;
in response to determining that the canine vest has lost connectivity with the mobile device, selecting a message to display using a plurality of lights of the canine vest; and
controlling the plurality of lights to display the selected message.
